(19) United States
(12) Patent Application Publication
(10) Pub. No.: US 2012/0158572 A1
(43) Pub. Date: Jun. 21, 2012

(54) Determining the Probability of an Action Being Performed by a Party at Imminent Risk of Performing the Action

(75) Inventors: Chitra Dorai, Chappaqua, NY (US); Eric R. Ray, Bloomfield Hills, MI (US); Gary L. Seybold, Weddington, NC (US); Anshul Sheopuri, White Plains, NY (US)

(73) Assignee: INTERNATIONAL BUSINESS MACHINES CORPORATION, Armonk, NY (US)

(21) Appl. No.: 12/969,044

(22) Filed: Dec. 15, 2010

(51) Int. Cl. G06N 5/02; G06Q 40/00

(52) U.S. Cl. 705/38; 706/52

(57) ABSTRACT

A computer implemented method, a data processing system, and a computer readable storage medium having a computer program product encoded thereon for determining a probability of an action being performed by a party at risk of performing the action. Input information that is pertinent to determining whether the party is at risk of performing the action is received by a data processing system. The data processing system forms an incentive structure for the party based on the received input information, the incentive structure comprising a probability of the party performing the action, and determines an optimal probability of the party performing the action based on the formed incentive structure.

### BACKGROUND

1. Field

The disclosure relates generally to a computer implemented method, a data processing system, and a computer readable storage medium having a computer program product encoded thereon. More specifically, the disclosure relates to a computer implemented method, a data processing system, and a computer readable storage medium having a computer program product encoded thereon for determining a probability of an action being performed by a party at risk of performing the action.

2. Description of the Related Art

There are many situations in which an action performed by a party, for example, an individual, may have an unsuitable effect. For example, in the financial services field, a default on a mortgage loan by a borrower may result in difficulties to both the borrower and to the financial institution or other lender that provided the mortgage. Similarly, in the human resources field, a key employee quitting his/her job may result in an employer being unable to easily replace the employee or to complete an important project. Yet further, in the health services field, the failure of a patient to obtain needed medical treatment may result in health problems for the patient.

Various mechanisms exist for predicting a likelihood of a party performing a particular action. In the financial services field, for example, the traditional focus of mortgage servicers in identifying loans that are at risk of default is to use various analytical models for predicting the likelihood of borrowers defaulting on their loans. Such models rely heavily on the borrower's past delinquency history, bankruptcy/foreclosure initiation, loan-to-value ratio, interest rates and other factors to predict the default likelihood. However, due to a general economic downturn, even those borrowers that have a good credit history “on the books” may consider defaulting on their loans depending on the circumstances. Early identification of such borrowers and a mechanism for offering such borrowers remedial strategies may be beneficial to the lender, the borrower and to the government in order to stave off widespread defaults. Currently, many remedial strategies exist that are sponsored by the government or by lenders. Such remedial strategies generally involve modifying an existing loan that is at risk by, for example, an interest rate reduction and/or a principal write-down of the loan.

Current mechanisms for identifying and modifying at-risk mortgage loans have not been particularly effective as the default rate for borrowers whose loans were modified remains quite high. Current data, in fact, suggests that mortgage loans that have been modified are defaulting at rates as high as fifty percent.

### SUMMARY

According to one embodiment of the present invention, a computer implemented method, a data processing system, and a computer readable storage medium having a computer program product encoded thereon are provided for determining a probability of an action being performed by a party at risk of performing the action. Input information that is pertinent to determining whether a party is at risk of performing an action is received by a data processing system. The data processing system forms an incentive structure for the party based on the received input information, the incentive structure comprising a probability of the party performing the action, and determines an optimal probability of the party performing the action based on the formed incentive structure.

### BRIEF DESCRIPTION OF THE SEVERAL VIEWS OF THE DRAWINGS

FIG. 1 depicts a pictorial representation of a network of data processing systems in which illustrative embodiments may be implemented;

FIG. 2 is an illustration of a block diagram of a data processing system in accordance with an illustrative embodiment;

FIG. 3 is an illustration of a diagram that schematically depicts an apparatus for determining a probability of an action being performed by a party at risk of performing the action, and for identifying an optimal remedial strategy to mitigate the risk in accordance with an illustrative embodiment;

FIG. 4A is an illustration that depicts an incentive-disincentive curve for a party at risk of performing an action in accordance with an illustrative embodiment;

FIG. 4B is an illustration that depicts an updated incentive-disincentive curve for the party in FIG. 4A in accordance with an illustrative embodiment; and

FIG. 5 is an illustration of a flowchart that schematically depicts a method for determining a probability of an action being performed by a party at risk of performing the action, and for identifying an optimal remedial strategy to mitigate the risk in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

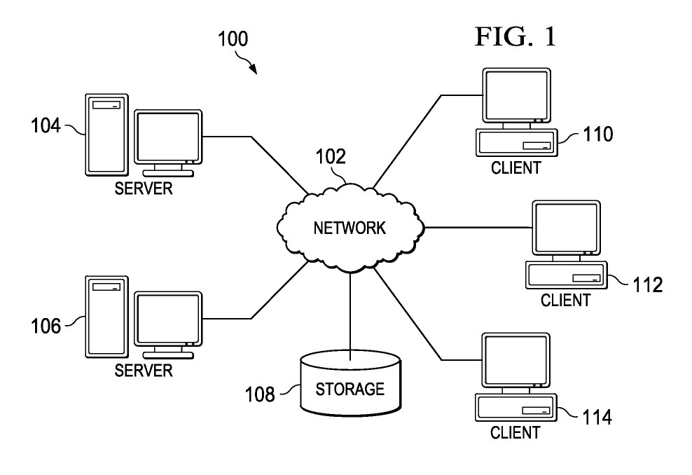

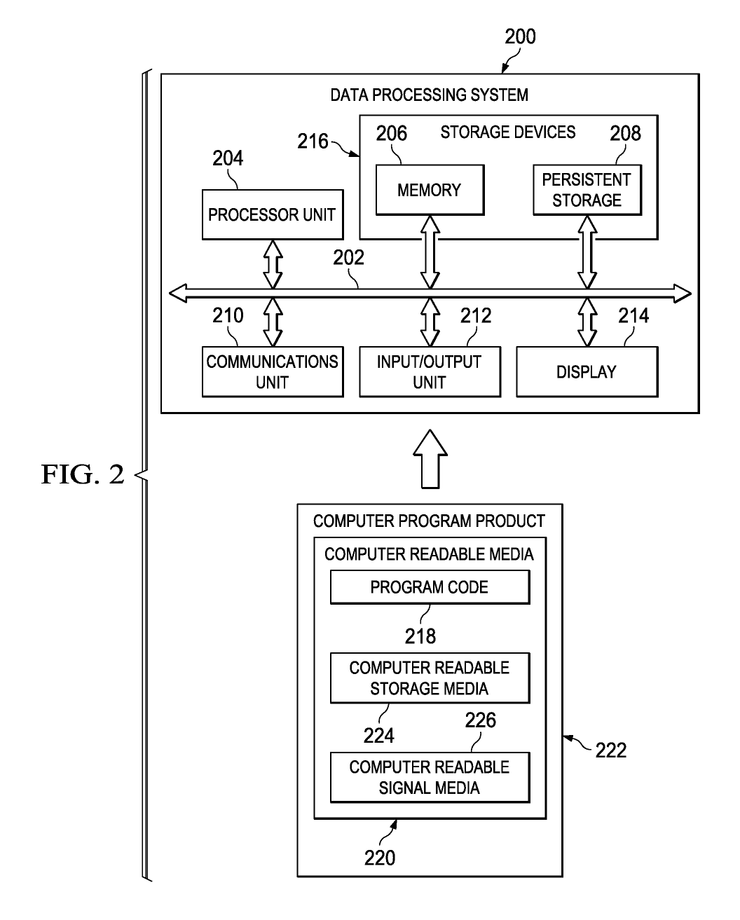

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides information, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 depicts a diagram of a data processing system in accordance with an illustrative embodiment. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments provide a computer implemented method, a data processing system, and a computer readable storage medium having a computer program product encoded thereon for determining a probability of an action being performed by a party at risk of performing the action. Input information that is pertinent to determining whether a party is at risk of performing an action is received by a data processing system. The data processing system forms an incentive structure for the party based on the received input information, the incentive structure comprising a probability of the party performing the action, and determines an optimal probability of the party performing the action based on the formed incentive structure.

In some illustrative embodiments described herein, the party is a borrower and the action is a default on a loan, for example, a mortgage loan. It should be understood, however, that it is not intended to limit illustrative embodiments to any particular party or to any particular action. For example, in other illustrative embodiments, the party may be an employee and the action may be quitting a job, or the party may be a patient and the action may be a failure to obtain medical treatment.

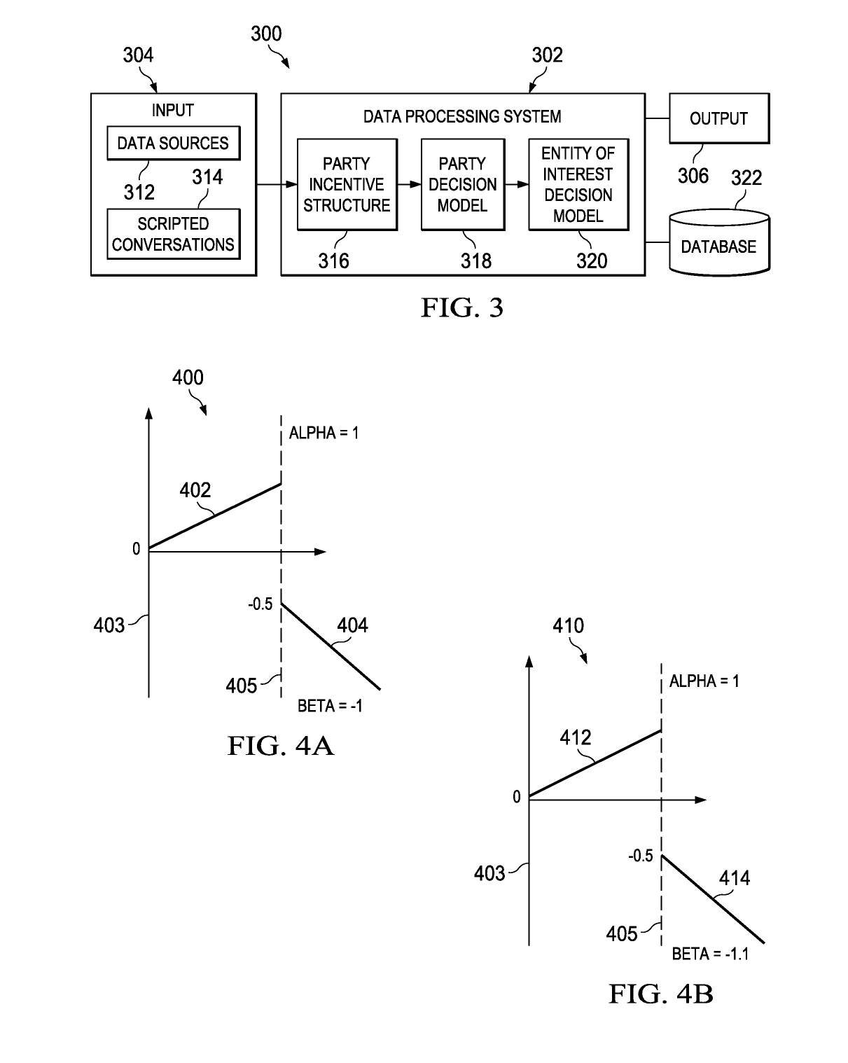

FIG. 3 is an illustration of a diagram that schematically depicts an apparatus for determining a probability of an action being performed by a party at risk of performing the action in accordance with an illustrative embodiment. The apparatus is generally designated by reference number 300, and includes data processing system 302. Data processing system 302 may, for example, be implemented as data processing system 200 in FIG. 2. Data processing system 302 receives, as an input 304, information pertinent to determining if a party is at risk of performing an action, and provides an output 306 that indicates the party's optimal imminent risk for performing the action. In addition, output 306 may provide an optimal remedial strategy for mitigating the risk.

In many illustrative embodiments, determining if a party is at risk of performing an action comprises determining if the party is at imminent risk of performing the action. Limiting the determination to parties that are at imminent risk of performing the action may enable a reduction in the population of those parties being evaluated, and may increase cost effectiveness in some applications. It should be understood, however, that it is not intended to limit illustrative embodiments to parties who are at an imminent risk of performing an action, as it may be desirable to examine all parties in some illustrative embodiments.

The determination of whether a party is at risk of performing an action may be based on various input information 304. For example, as shown in FIG. 3, the input information may include external information obtained from heterogeneous data sources 312 and information obtained using one or more scripted conversations with the party 314. As will be explained more fully hereinafter, the type of information that is gathered and used to make the determination of whether a party is at risk of performing an action depends on the particular action that is at risk of being performed and on the party. In general, however, the information that is gathered and used is information that will identify factors that may encourage or discourage the party from performing the particular action. For example, if the party is a borrower and the action at risk of being performed is a default on a mortgage loan, the type of external information that may be gathered from heterogeneous data sources may include information that is specific to the location of the property for which the mortgage was obtained such as unemployment and wage statistics for the neighborhood, retail sales and lifestyle information, census data on worker flow and foreclosure rate data for the neighborhood. Information obtained using scripted conversations with the party may include, for example, information regarding whether the party recently conducted a home renovation, whether the party's children attend local schools, how long the party has lived in the neighborhood, whether the party's extended family lives in the neighborhood and whether the neighborhood has good after-school options. Details of the content and sequence of the scripted conversations may be determined in consultation with subject matter experts and compliance teams.

As will be described more fully hereinafter, input information 304, which may be stored in database 322, is used by data processing system 302 to determine if there is a risk of the action being performed by the party by determining optimal decision points for the party with respect to performing the action. In accordance with an illustrative embodiment, this is achieved by using the input information to develop or update an incentive structure 316 for the party and then using the incentive structure to determine a decision model 318 for the party, i.e., the party's optimal probability for performing the action. As will also be described more fully hereinafter, determining whether remedial action should be offered and the nature of the remedial action to be offered is achieved by creating or updating a decision model 320 for an entity-of-interest that may offer the remedial action. For example, if the party is a borrower and the action at risk of being performed is a default on a mortgage loan, the entity-of-interest may be the lender.

In accordance with an illustrative embodiment, the incentive structure for the party is an “incentive-disincentive curve.” FIG. 4A is an illustration that depicts an incentive-disincentive curve for a party at risk of performing an action in accordance with an illustrative embodiment. The incentive-disincentive curve is generally designated by reference number 400 and includes an incentive curve 402 and a disincentive curve 404. Incentive-disincentive curve 400 comprises an incentive-disincentive curve for the party prior to the curve being updated to reflect input information that has been gathered. Incentive curve 402 has a slope alpha=1 and an intercept of axis 403=0. Disincentive curve 404 has a slope beta=−1 and an intercept of axis 405=−0.5. The parameters of the incentive and disincentive curves 402 and 404 illustrated in FIG. 4A may be determined by a subject matter expert in the field the action pertains to by incorporating the expert's understanding of the costs and benefits of performing the particular action.

Assume, in accordance with an illustrative embodiment, that the party is a borrower and that the action at risk of being performed is a default on a mortgage loan. Assume also that as a result of input information that has been captured from data sources and from a scripted conversation with the borrower, it is determined that the borrower has recently conducted renovations on his property and has extended family living in his neighborhood. These are factors that may discourage the borrower from defaulting on his mortgage loan and, thus, that will affect the borrower's disincentive curve 404. FIG. 4B is an illustration that depicts an updated incentive-disincentive curve for the party in FIG. 4A in accordance with an illustrative embodiment. The updated incentive-disincentive curve is generally designated by reference number 410 and includes incentive curve 412 and disincentive curve 414. As illustrated in FIG. 4B, incentive curve 412 is the same as incentive curve 402 in FIG. 4A in that the slope of the curve is unchanged as alpha=1. This means that the input information that has been gathered does not increase the borrower's likelihood of performing the action.

Disincentive curve 414, however, has been updated as a result of the input information to have a slope of beta=−1.1. This means that the input information, i.e., information indicating that the borrower has recently conducted renovations on his property and has extended family living in his neighborhood, decreases the likelihood of the borrower defaulting on the mortgage loan.

Once the incentive-disincentive curve (party incentive structure 316 in FIG. 3) of the borrower has been updated, the optimal borrower probability of performing the action (party decision model 318 in FIG. 3) is determined based on the updated incentive structure. Based on the updated incentive-disincentive curve, the optimal borrower probability may be determined either using a heuristic search, if the expected utility is a non-convex function, or an efficient search technique if the function is convex.

Once the party's optimal probability of performing the action is determined, an optimal remedial strategy may be determined based on the party's optimal probability of performing the action. The optimal remedial strategy may be to do nothing, or to take a suitable remedial action to reduce the party's optimal probability of performing the action. If it is determined that remedial action is to be offered, the type of incentive(s) a party of interest should offer to reduce the party's optimal probability of performing the action is determined.

Assuming again that the party is a borrower, the entity of interest is a lender, and that the action at risk of being performed is a default on a mortgage loan, an optimal remedial strategy can be determined by computing the lender's preferred default probability p_d for the borrower. For example,

p_d=acceptable expected loss from default of loan.

If the borrower's optimal default probability P* is much higher than p_d, the lender should be concerned enough to consider approaching the borrower with a remedial action.

An optimal remedial strategy may achieve a shift in the borrower's optimal probability of defaulting on the mortgage loan from P* to p_d. This may be accomplished, for example, by determining the combination of levers (e.g., interest rate reduction, debt forgiveness) of the lender to achieve the desired reduction in the borrower's optimal probability of defaulting on the mortgage loan. Then, the preferred remedial action is determined based on the lender's financial and operational constraints. For example, operational constraints may include laws that do not permit the lender to offer remedial plans to all borrowers. One rule that may be used to determine an amount of incentive to present to the borrower might be (p*−p_d)* loss given default where loss given default is the amount of loss that will be incurred by the lender if the loan were to default.

Both the borrower's incentive structure (party incentive structure 316 in FIG. 3) and the lender's decision model (entity of interest decision model 320 in FIG. 3) may be updated using information learned during the overall process of determining a probability of a borrower defaulting on a mortgage loan, and for identifying a remedial strategy for addressing the risk. With respect to the borrower's incentive structure, the borrower's incentive-disincentive curve may be customized based on the outcome of the overall process. With respect to the lender decision model, the model may be updated using trends about which levers or combinations of levers were accepted by the borrower to achieve a desired reduction in the borrower's optimal default probability.

As indicated above, although illustrative embodiments have been described primarily in connection with a mortgage loan environment, it should be understood that this is intended to be exemplary only as illustrative embodiments may include any party who may be at risk of performing any type of action. In the human resources field, for example, the party may be an employee, for example, a salesman, and the action at risk of being performed may be the employee quitting his/her job. In such a situation, the party decision model may model the probability of the employee leaving the company and the entity of interest decision model may model the incentives that may be offered by the employer to increase the retention probability of the employee.

In an employee retention environment, examples of incentive factor inputs and disincentive factor inputs, which may be learned using a scripted conversation between the employee and another company employee, include whether the employee has skills that are in high demand, whether the local economy offers other opportunities, and the like. The determination of whether incentives should be offered to retain the employee may be based on an employee utility model that incorporates leaving likelihood. An example of employee utility is the employee's profit from an activity. This is modeled as a function of the employee's likelihood to leave. If the employee has a high utility, as the likelihood of the employee leaving increases, better incentives may be offered to the employee to retain him/her. On the other hand, if the employee's utility is low, it may be decided not to offer incentives even as the likelihood of the employee leaving increases. Examples of incentives that may be offered to an employee to retain the employee may include one or more of an increase in compensation, a promotion, a bonus and reduced working hours.

In the health services field, the party may be a patient and the behavior may be a failure to obtain medical care. In such a situation, the party decision model may model the probability of the patient seeking and obtaining the medical care, and the party of interest decision model may model whether incentives should be offered to the patient (for example, by a doctor or other party of interest) to increase the probability that the patient will seek the medical care. In the health services field, incentive-disincentive factor inputs may be whether the patient was exposed to a health hazard, how long the patient was exposed to the health hazard, whether the patient is able to drive to a location where treatment can be provided and whether the patient has sufficient income to afford the medical care. The determination of whether incentives should be offered to a patient is based on a patient utility model that compares the patient's apathy. An example of a patient's utility is the patient's profits from an activity. This is modeled as a function of the patient's medical apathy. If the patient has a high patient utility, better incentives may be offered to convince the patient to accept the medical care. On the other hand, if the patient has a low utility, incentives may not be offered even as the patient's medical apathy increases. If it is determined that incentives should be offered, examples of incentives that may be offered to the patient to increase the probability of the patient obtaining the medical care includes one or more of providing free health care, discounted health care, reduced insurance premiums and transportation to and from a health facility.

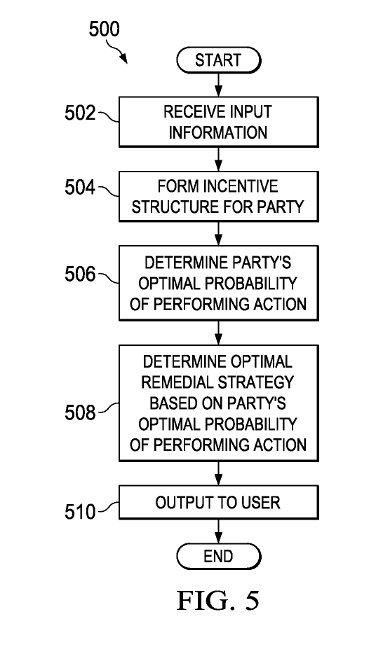

FIG. 5 is an illustration of a flowchart that schematically depicts a method for determining a probability of an action being performed by a party at risk of performing the behavior, and for identifying an optimal remedial strategy to mitigate the risk in accordance with an illustrative embodiment. The process is generally designated by reference number 500, and may be implemented in system 300 in FIG. 3. Process 500 may begin by receiving input information that may be pertinent to determining whether a party is at risk of performing an action (Step 502). In accordance with an illustrative embodiment, the input information may include information from heterogeneous data sources and information from one or more scripted conversations with the party.

The input information is used to form an incentive structure for the party (Step 504). The incentive structure may, for example, be an incentive-disincentive curve for the party, and the input information may be at least one of an incentive factor input and a disincentive factor input used to update the incentive-disincentive curve. The updated incentive structure may then be used to determine the party's optimal probability of performing the action (Step 506).

An optimal remedial strategy is then determined based on the party's optimal probability of performing the action (Step 508). The optimal remedial strategy may be to do nothing, or to take a suitable remedial action to reduce the party's optimal probability of performing the action. The determinations may then be output to a user (Step 510), and the process ends.

Illustrative embodiments thus provide a computer implemented method, a data processing system, and a computer readable storage medium having a computer program product encoded thereon for determining a probability of an action being performed by a party at risk of performing the action. Input information that is pertinent to determining whether a party is at risk of performing an action is received by a data processing system. The data processing system forms an incentive structure for the party based on the received input information, the incentive structure comprising a probability of the party performing the action, and determines an optimal probability of the party performing the action based on the formed incentive structure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining a probability of an action being performed by a party at risk of performing the action, comprising:
receiving input information by a data processing system, the input information comprising information pertinent to determining whether a party is at risk of performing an action;
forming, by the data processing system, an incentive structure for the party based on the received input information, the incentive structure comprising a probability of the party performing the action; and
determining, by the data processing system, an optimal probability of the party performing the action based on the formed incentive structure.

2. The method of claim 1, wherein receiving input information comprises receiving input information from at least one of a data source and a conversation with the party.

3. The method of claim 1, wherein forming an incentive structure for the party comprises forming an incentive-disincentive curve for the party, and wherein the input information comprises at least one of an incentive factor input and a disincentive factor input, the incentive factor input comprising a variable that encourages the party to perform the action and the disincentive factor input comprising a variable that discourages the party from performing the action.

4. The method of claim 1, wherein determining an optimal probability of the party performing the action comprises determining the optimal probability of the party performing the action using one of a heuristic search or an efficient search technique.

5. The method of claim 3, wherein forming the incentive structure for the party comprises updating the incentive-disincentive curve based on the received input information.

6. The method of claim 1, and further comprising:
determining, by the data processing system, an optimal remedial strategy based on the optimal probability of the party performing the action.

7. The method of claim 6, wherein determining an optimal remedial strategy based on the optimal probability of the party performing the action, comprises comparing the optimal probability of the party performing the action with a preferred default probability of a party of interest.

8. The method of claim 7, wherein the preferred default probability of the party of interest comprises an acceptable loss from the party performing the action.

9. The method of claim 1, wherein the party is a borrower and the action at risk of being performed by the party is a default on a loan.

10. The method of claim 1, wherein the party is an employee and the action at risk of being performed by the party is quitting a job.

11. The method of claim 1, wherein the party is a patient and the action at risk of being performed by the party is a failure to obtain medical treatment.

12. A computer program product, comprising:
a computer readable storage medium having computer program product encoded thereon for determining a probability of an action being performed by a party at risk of performing the action, the computer program product comprising:
instructions for receiving input information by a data processing system, the input information comprising information pertinent to determining whether a party is at risk of performing an action;
instructions for forming, by the data processing system, an incentive structure for the party based on the received input information, the incentive structure comprising a probability of the party performing the action; and
instructions for determining an optimal probability of the party performing the action based on the formed incentive structure.

13. The computer program product of claim 12, wherein the instructions for receiving input information comprises instructions for receiving input information from at least one of a data source and a conversation with the party.

14. The computer program product of claim 12, wherein the instructions for forming an incentive structure for the party comprises instructions for forming an incentive-disincentive curve for the party, and wherein the input information comprises at least one of an incentive factor input and a disincentive factor input, the incentive factor input comprising a variable that encourages the party to perform the action and the disincentive factor input comprising a variable that discourages the party from performing the action.

15. The computer program product of claim 12, wherein the instructions for determining an optimal probability of the party performing the action comprises instructions for determining the optimal probability of the party performing the action using one of a heuristic search or an efficient search technique.

16. The computer program product of claim 14, wherein the instructions for forming the incentive structure comprises instructions for updating the incentive-disincentive curve based on the received input information.

17. The computer program product of claim 12, and further comprising:
instructions for determining an optimal remedial strategy based on the optimal probability of the party performing the action.

18. The computer program product of claim 17, wherein the instructions for determining an optimal remedial strategy based on the optimal probability of the party performing the action, comprises instructions for comparing the optimal probability of the party performing the action with a preferred default probability of a party of interest.

19. The computer program product of claim 12, wherein the party is a borrower and the action at risk of being performed by the party is a default on a loan.

20. The computer program product of claim 12, wherein the party is an employee and the action at risk of being performed by the party is quitting a job.

21. The computer program product of claim 1, wherein the party is a patient and the action at risk of being performed by the party is a failure to obtain medical treatment.

22. An apparatus, comprising:
a bus;
a communications unit connected to the bus;
a storage device connected to the bus, wherein the storage device includes program code; and
a processor unit connected to the bus, wherein the processor unit executes the program code to:
receive input information, the input information comprising information pertinent to determining whether a party is at risk of performing an action;
form an incentive structure for the party based on the received input information, the incentive structure comprising a probability of the party performing the action; and
determine an optimal probability of the party performing the action based on the formed incentive structure.

23. The apparatus of claim 22, wherein form an incentive structure for the party comprises form an incentive-disincentive curve for the party, and wherein the input information comprises at least one of an incentive factor input and a disincentive factor input, the incentive factor input comprising a variable that encourages the party to perform the action and the disincentive factor input comprising a variable that discourages the party from performing the action.

24. The apparatus of claim 22, wherein determine an optimal probability of the party performing the action comprises determine the optimal probability of the party performing the action using one of a heuristic search or an efficient search technique.

25. The apparatus of claim 22, wherein the processor further executes the program code to determine an optimal remedial strategy based on the optimal probability of the party performing the action, wherein determine an optimal remedial strategy based on the optimal probability of the party performing the action, comprises compare the optimal probability of the party performing the action with a preferred default probability of a party of interest.
